(19) United States
(12) Patent Application Publication
(10) Pub. No.: US 2012/0144896 A1
(43) Pub. Date: Jun. 14, 2012

(54) APPARATUS TO DETERMINE COEFFICIENT OF FRICTION

(75) Inventors: Hoang T. Pham, Lake Jackson, TX (US); Roger B. Barthlome, Bailey's Prairie, TX (US)

(73) Assignee: Dow Global Technologies LLC, Midland, MI (US)

(21) Appl. No.: 13/386,686

(22) PCT Filed: Aug. 11, 2010
(86) PCT No.: PCT/US10/45117

§ 371 Date: Jan. 24, 2012

Related U.S. Application Data
(60) Provisional application No. 61/233,307, filed on Aug. 12, 2009.

(51) Int. Cl. G01N 19/02

(52) U.S. Cl. 73/9

(57) ABSTRACT

The invention provides an apparatus for the continuous measurement of the dynamic coefficient of friction and/or static coefficient of friction of a material, which comprises at least the following: A) two rotating rollers, R1 and R2, B) one roller S1, C) optionally, one static roller S2, D) two sets of force detectors, F1 and F2, and wherein S1 is located between R1 and R2 to form a wrap angle (?), and wherein the wrap angle (?) is less than 90°, and wherein F1 is attached to R1, and F2 is attached to R2. The invention also provides an apparatus for the continuous measurement of the coefficient of friction (dynamic and/or static) and the pull force of a material, which comprises at least the following: A) two rotating rollers, R1 and R2, B) three rollers, R3, R4 and R5, C) one roller S1, D) optionally, one static roller S2, E) three sets of force detectors, F1, F2 and F3, and wherein S1 is located between R1 and R2 to form a wrap angle (?), and wherein the wrap angle (?) between R1 and R2 is less than 90°, and wherein R3, R4 and R5, are each located upstream from R2; and wherein F1 is attached to R1, F2 is attached to R2, and F3 is attached to R3.

### REFERENCE TO RELATED APPLICATIONS

This application claims the benefit of U.S. Provisional Application No. 61/233,307, filed on Aug. 12, 2009, and fully incorporated herein by reference.

### BACKGROUND OF THE INVENTION

The invention relates to an apparatus for the continuous determination of the coefficient of friction (COF) of a material, and, in particular, the COF of a film or sheet. The invention also relates to the continuous determination of COF and pull force of a material, and in particular, of a film or sheet.

There is a critical need for film suppliers and film converters, for films and sheets that have a consistent COF throughout the surface of the film and sheet. Presently there are no suitable solutions for on-line, or at-line, COF measurements in the film industry. The current worldwide procedure is to measure COF on different areas of the film, using a separate off-line procedure.

One method that is currently used for determining the coefficient of friction is the standard method ASTM D-1894. This method determines the local static and dynamic (also known as kinetic) coefficient of friction of the film or sheet at the surface of another film or at a metal surface. This test method does not provide the COF or slip behavior of the whole roll of film. In order to fully characterize the COF and slip behavior of a roll of film or sheet, one needs a test method that can measure COF in a continuous manner. This COF method should allow for the characterization of the slip performance of the roll of film or sheet, as it is unwound in a continuous on line process.

There is a further need for an “at-line tester” that is able to non-destructively determine the dynamic COF of a film during fabrication processes, and which can use this COF information to differentiate films made using a variety of slip formulations. Slip behavior is a surface phenomenon that is characterized through the measure of the coefficient of friction. There are two coefficients that are of interest. The first is called the static coefficient of friction. The static coefficient of friction is defined as the ratio of the normal force to the force required to initially move an object on a given surface. The second is the dynamic coefficient of friction, also known as kinetic coefficient of friction, and is defined as the ratio of the normal force to the force required to maintain a steady state motion of an object sliding on a given surface. The determination of these coefficients of friction can be done in many geometric ways, however, the common way is to determine the force required to initiate and maintain an object sliding on a surface.

The reference, Friction of Polymer Films, by D. K. Owens, J. Appl. Polym. Sci., Vol. 8, pp. 1465-1475 (1964), discloses an apparatus using a rotating drum, on which is hung a pre-tension strip of film or fiber. The hung film or fiber is pre-tensioned on one leg using a known weight or force, while the other leg is attached to a strain gage or load cell. As the pre-tensioned film strip or fiber is pulled by a rotating pick-up drum, the frictional forces are measure via a strain gage or load cell. This is a lab scale method, and not applicable to “on-line” measurements. Additionally, the design showed a wrap angle of greater than, or equal to, 180°, which is not suitable for a continuous “on-line” or “at-line” process using a film web, since a high wrap angle will produce a high web tension, which may cause defects within the film or sheet roll, such as static charge and blocking effects. For example, a film or sheet may wrinkle, and cause the roll to collapse when the film or sheet is tightly wound. See also,” Boundary Friction of Textile Yarns,” by F. Tomlinson, Jr. and J. S. Olsen, Textile Research J., 31, 1007-1011, (1961).

The reference, “Adsorption and Boundary Friction of Polymer Surfaces,” by F. Tomlinson, Jr., J. Phys. Chem., Vol. 66, 1136-1143 (1962), discloses a sliding device for determination of the friction of a film. The device consists of a variable speed turntable and a pivoted lever arm that is attached to a strain gage. As the turntable rotates, the sliding friction force between the film and the lever arm is recorded via a strain gage. This described method is not applicable for a continuous “on-line” determination of COF.

Japanese Patent Publication No. P2001-66205A discloses an “on-line” sheet tension detector that uses a freely rotating textured roller, which is supported with a load measuring device. The textured roller is specified to have a fiction coefficient of greater than 0.8 with respect to the film surface. As the web presses on the textured roller, the normal force is measured, and converted to web tension. In order to measure the COF of the textured roller in contact with the film web, another method was described, which requires taking the apparatus off-line. The determination of COF uses a pre hung weight. Such a device is not suitable for continuous “on-line” or “at-line” measurements of COF.

U.S. Pat. No. 5,319,578 discloses a yarn profile analyzer, in which the yarn is moved under substantially constant tension through an imaging area, including a light source and a spaced light sensing array. This patent discloses tension measuring devises containing three rollers, with a middle roller connected to a mechanical spring, used to detect the tension of the yarn. These devices are not used to measure the coefficient of friction, and in most cases, do not provide sufficient accuracy for measuring the coefficient of friction. See also U.S. Pat. No. 5,420,802.

The British Patent Specification GB 1286112 discloses an apparatus to measure the coefficient of friction for a film or sheet, using a sliding motion on an inclined surface. As the inclined surface is tilted, the sheet or film slides, and the inclination angle relates to the coefficient of friction. This method is not easily adaptable to an “on-line” or “at-line” process.

Finland Patent Application FI981198 (Summary or Abstract) discloses an apparatus to determine coefficient of friction of a floor or an underlayment layer. The apparatus consist of a stem, applied normal loading, a transmission, and a friction detector or transducer. Although described as an in-situ device, the design is not valid for a continuous film web process.

An apparatus to determine the coefficient of friction for yarn is also described in the reference Apparatus for Determining the Coefficient of Friction of Running Yarn, by F. Breazeale, Textile Research J., No. 4, Vol. XVII, pp. 27-31 (1947). The apparatus, as described, requires a contacting wheel that forms a wrap angle of 180°. This large wrap angle cannot be used in an “on-line” or “at-line” apparatus due to the formation of wrinkles in the film web, and the large wrap angle may also cause excessive tension when winding the films.

The reference Amonton's Law and Fibre Friction, by H. G. Howell and J. Mazur, J. Textile Inst., 44, T59-T69 (1953) describes an apparatus used to determine friction coefficient of fibers using the Amonton's law. This apparatus, as described, is not easily adaptable to a continuous production environment.

The reference Some Measurements of the Friction of Wool and Mohair, by A. J. P Martin and R. Mittelmann, J Textile Inst., T269-T280, December (1946), describes a stand alone apparatus to determine the coefficient of friction of wool and mohair fibers. The apparatus, as described, is a stand alone unit, and the design is not practical for used in a continuous production environment.

The reference, The General Case of Friction of a String Round a Cylinder, by H. G. Howell, Journal of the Textile Institute, No. 8/9, pp. 359-362 (1953), discloses the theoretical aspect of the determination of coefficient of friction of a fiber, using the ratio of the tension forces about a frictional point. This reference does not provide any particular apparatus designs.

Additional friction-relating devices, abrasion devices, and/or theoretical constructions relating to friction, are described in the following references: a) S. Bahadur, Dependence of Polymer Sliding Friction on Normal Load and Contact Pressure, Wear, 29, 323-336, (1974); b) K. G. Budinski, An Inclined Plane Test for the Breakway Coefficient of Rolling Friction of Rolling Elements Bearings, Wear, 259, 1443-1447 (2005); c) B. Olofasson, Measurement of Friction Between Single Fibers VI. Theoretical Study of Fiber Friction, Textile Research Journal, 476-480 (1950); d) V. E. Gonnsalves, Theoretical Considerations and Measurements with Regard to the Longitudinal Abrasion of Rayon Filaments, Textile Research Journal, 28-42 (1950); e) German Patent Application DE 102006028020A1, and f) ASTM D 3108-07. There are also commercial “off-line” devices available to measure the COF of fibers (for example, an Elastomeric Yarn Tester, Model CIT-E LH 450, available from LAWSON-HEMPHILL).

As discussed above, there is a need for a device that can measure the COF (dynamic and/or static) of a roll of a flat substrate, such as a film or sheet, continuously, and in a non-destructive manner. There is also a need for a COF device that can be incorporated into a film line, such as a blown line, a cast film or sheet line, a film or sheet lamination line, or a film or sheet coating line. There is also a need for a device that can be used for the instantaneous measurement of COF of a film or sheet, as it is wound into rolls, or as it is used in an on-line or at-line process with other devices, such as a slitter rewinder and form-fill-seal (FFS) equipment. These needs and others have been met by the following invention.

### SUMMARY OF THE INVENTION

The invention provides an apparatus for the continuous measurement of the dynamic coefficient of friction and/or the static coefficient of friction of a material, which comprises at least the following:

A) two freely rotating rollers, R1 and R2,

B) one roller S1,

C) optionally, one static roller S2,

D) two sets of force detectors, F1 and F2, and

wherein S1 is located between R1 and R2 to form a wrap angle (θ), and wherein the wrap angle (θ) is less than 90°, and

wherein F1 is attached to R1, and F2 is attached to R2.

The invention also provides an apparatus for the continuous measurement of the coefficient of friction (dynamic and/or static) and the pull force of a material, which comprises at least the following:

A) two freely rotating rollers, R1 and R2,

B) three rollers, R3, R4 and R5,

C) one roller S1,

D) optionally, one static S2,

E) three sets of force detectors, F1, F2 and F3, and

wherein S1 is located between R1 and R2 to form a wrap angle (θ), and wherein the wrap angle (θ) between R1 and R2 is less than 90°, and

wherein R3, R4 and R5, are each located upstream from R2; and

wherein F1 is attached to R1, F2 is attached to R2, and F3 is attached to R3.

### BRIEF DESCRIPTION OF THE DRAWINGS

FIG. 1 depicts roller elements, including wrap angle (θ) of an inventive apparatus.

FIG. 2 is a schematic of an “at-line” apparatus for the continuous determination of the COF (dynamic and/or static) and/or pull force of a film or sheet. The top cross-section view, denoted “A-A”, is a cross-section of the anchor plate denoted as “circle A—circle A”, in the side view of the apparatus shown in FIG. 2. In this figure, “upstream” refers to a direction towards the web entrance, and “downstream” refers to a direction towards the web exit.

FIG. 3 is a schematic of a pair of load detection devices, a roller and a bearing housing.

FIG. 4 depicts a dynamic COF profile (COF versus time) of a roll of film.

### DETAILED DESCRIPTION OF THE INVENTION

The invention provides a method for the continuous determination of the coefficient of friction (dynamic and/or static) of a material. In particular, the coefficient of friction of whole rolls of films or sheets can be determined, as the films or sheets are being used in a fabrication process. The apparatus can also be used to determine the unwinding force (or pull force) of the roll of film or sheet. Further, the apparatus can be used to measure a film COF “on-line” or “at line” during a blown film process, a cast film or sheet process, an extrusion coating, a lamination process, or a form fill and sealing (FFS) process.

The apparatus is particularly suited for an “on-line” or “at-line” blown film process, and a slitter rewinding process. The apparatus is also sensitive enough to detect the defects in the film. The apparatus is particularly suited for operation with an existing film or sheet line, which has an external drive unit. Optionally, a drive unit to wind and unwind the films can be incorporated into the apparatus for use as a stand alone device.

The apparatus is also designed to determine the coefficient of friction of a coating, directly in an “in-line” coating process, and/or during a further conversion step, like a lamination or a rewinding process. When used on a film, sheet or coating process, the resulting data can serve as a control measure of the end product, and using a control feedback loop, the film, sheet, coating composition, or substrate, can be adjusted automatically. The inventive apparatus will enable the characterization of the slip performance of the roll of film or sheet as it is unwound on line.

The coefficient of friction (dynamic and/or static) is a critical parameter that is commonly used in the flexible packaging industry to characterize the performance of thin blown or cast films or sheets. COF is a very important property for laminated and non-laminated films or sheets that are further converted into finished packaging, using vertical-form-fill-and-seal (VFFS) or horizontal form-fill-and-seal (HFFS) machinery. The COF of films or sheets is traditionally measured using an “off-line” COF tester with very small samples taken from a larger film or sheet roll. The results thus obtained may not be representative of the true performance of the film or sheet roll on converting machinery, such as an adhesive laminator or VFFS/HFFS equipment. As discussed above, a continuous film and/or sheet apparatus, (for example, an “at-line COF tester”) was designed and developed for the purpose of understanding the dynamic COF profile of the entire roll of film. The inventive COF tester enables the measurement of COF at various line speeds and against various surfaces, including metals or rubber. In addition, the film's dynamic COF, as measured by the inventive apparatus, can be correlated to performance on a VFFS line. This offers a valuable tool for predicting the COF-related performance of a film roll in various steps in the flexible packaging value chain, including film conversion, adhesive lamination, and VFFS/HFFS packaging production.

As discussed above, the invention provides an apparatus for the continuous measurement of the dynamic coefficient of friction and/or static coefficient of friction of a material, which comprises at least the following:

A) two freely rotating rollers, R1 and R2,

B) one roller S1,

C) optionally, one static roller S2,

D) two sets of force detectors, F1 and F2, and

wherein S1 is located between R1 and R2 to form a wrap angle (θ), and wherein the wrap angle (θ) is less than 90° (1.57 radians), and wherein R1 is attached to F1 and R2 is attached to F2.

Means of attachment of a roller to a force detector include, but are not limited to, pillow blocks in the horizontal or vertical position. Other means of attachments are also known by those skilled in the art; for example shaft mounting, which is typically used with radial load cell(s).

In one embodiment, the dynamic coefficient of friction is measured.

In one embodiment, the static coefficient of friction is measured.

In one embodiment, the dynamic coefficient of friction and the static coefficient of friction are measured.

In one embodiment, the material is a film, sheet or fiber.

In one embodiment, the material is a film. A film typically has a thickness up to, and including, 12 mils (1 mil=1/1000 inch=0.0254 mm)

In one embodiment, the material is a sheet. A sheet typically has a thickness greater than 12 mils.

In one embodiment, the material is a fiber.

In one embodiment, the apparatus is part of a manufacturing or production line.

In one embodiment, the apparatus is an “on-line” apparatus.

In one embodiment, the apparatus is an “at-line” apparatus.

In one embodiment, the two force detectors (F1 and F2) are each load cells.

In one embodiment, the two rollers R1 and R2 have the same diameter.

In one embodiment, the wrap angle is less than, or equal to, 60° (1.05 radians).

In one embodiment, the wrap angle is less than, or equal to, 45° (0.785 radians), preferably less than, or equal to, 40°.

In one embodiment, the wrap angle is less than, or equal to, 30° (0.52 radians), preferably less than, or equal to, 20°.

In one embodiment, the wrap angle is less than, or equal to, 20° (0.35 radians), preferably less than, or equal to, 10°.

In one embodiment, roller S1 is rotational or stationary (static).

In one embodiment, roller S1 is stationary.

In one embodiment, roller S1 is rotational.

In one embodiment, S1 has a diameter from 0.5 inches to 6 inches, preferably from 0.75 inches to 4.5 inches.

In one embodiment, each roller, R1, R2 and S1 has the same diameter.

In one embodiment, each roller, R1, R2 and S1 has the same length.

In one embodiment, data acquisition rate for each load cell (tension) is one data point per “10 microseconds or more.”

In one embodiment, the speed of the material (for example, a film), as it passes through the apparatus, is from “ten feet per minute” to “1000 feet per minute.”

In one embodiment, the speed of the material (for example, a film), as it passes through the apparatus, is from “twenty feet per minute” to “500 feet per minute.”

An inventive apparatus may comprise a combination of two or more embodiments as described herein.

The invention also provides an apparatus for the continuous measurement of the dynamic coefficient of friction and/or static coefficient of friction of a material, which comprises at least the following:

A) two freely rotating rollers, R1 and R2,

B) one roller S1,

C) optionally, one static roller S2,

D) two force detectors, Fa and Fb, and

wherein S1 is located between R1 and R2 to form a wrap angle (θ), and wherein the wrap angle (θ) is less than 90° (1.57 radians), and wherein R1 is attached to Fa and R2 is attached to Fb. The means of attachment and embodiments described above and throughout this application also apply to this apparatus. Preferably, the dynamic coefficient of friction is measured. The inventive apparatus may comprise a combination of two or more embodiments as described herein.

The invention also provides an apparatus for the continuous measurement of the coefficient of friction (dynamic and/or static) and the pull force of a material, which comprises at least the following:

A) two freely rotating rollers, R1 and R2,

B) three rollers, R3, R4 and R5,

C) one roller S1,

D) optionally, one static roller S2,

E) three sets of force detectors, F1, F2 and F3, and

wherein S1 is located between R1 and R2 to form a wrap angle (θ), and wherein the wrap angle (θ) between R1 and R2 is less than 90°, and wherein R3, R4 and R5, are each located upstream from R2; and wherein F1 is attached to R1, F2 is attached to R2, and F3 is attached to R3.

Means of attachment of a roller to a force detector include, but are not limited to, pillow blocks in the horizontal or vertical position. Other means of attachments are also known by those skilled in the art; for example shaft mounting, which is typically used with radial load cell(s).

In one embodiment, the coefficient of friction and the pull force are simultaneous measured.

In one embodiment, the coefficient of friction and the pull force are alternately measured.

In one embodiment, the dynamic coefficient of friction is measured.

In one embodiment, the static coefficient of friction is measured.

In one embodiment, the dynamic coefficient of friction and the static coefficient of friction are measured.

In one embodiment, the material is a film, sheet or fiber.

In one embodiment, the material is a film. A film typically has a thickness up to, and including, 12 mils.

In one embodiment, the material is a sheet. A sheet typically has a thickness greater than 12 mils.

In one embodiment, the material is a fiber.

In one embodiment, the apparatus is part of a manufacturing line.

In one embodiment, the apparatus is an “on-line” apparatus.

In one embodiment, the apparatus is an “at-line” apparatus.

In one embodiment, the two force detectors (F1 and F2) are each a load cell.

In one embodiment, the two rollers R1 and R2 have the same diameter.

In one embodiment, the wrap angle is less than, or equal to, 60° (1.05 radians).

In one embodiment, the wrap angle is less than, or equal to, 45° (0.785 radians), preferably less than, or equal to, 40°.

In one embodiment, the wrap angle is less than, or equal to, 30° (0.52 radians), preferably less than, or equal to, 20°.

In one embodiment, the wrap angle is less than, or equal to, 20° (0.35 radians), preferably less than, or equal to, 10°.

In one embodiment, roller S1 is rotational or stationary (static).

In one embodiment, roller S1 is stationary.

In one embodiment, roller S1 is rotational.

In one embodiment, S1 has a diameter from 0.5 inches to 6 inches, preferably from 0.75 inches to 4.5 inches.

In one embodiment, each roller, R1, R2 and S1 has the same diameter.

In one embodiment, each roller, R1, R2 and S1 has the same length.

In one embodiment, data acquisition rate for each load cell (tension) is one data point per “10 microseconds or more.”

In one embodiment, the speed of the material (for example, a film), as it passes through the apparatus, is from “ten feet per minute” to “1000 feet per minute.”

In one embodiment, the speed of the material (for example, a film), as it passes through the apparatus, is from “twenty feet per minute” to “500 feet per minute.”

An inventive apparatus may comprise a combination of two or more embodiments as described herein.

### Theoretical Analysis of Inventive Apparatus

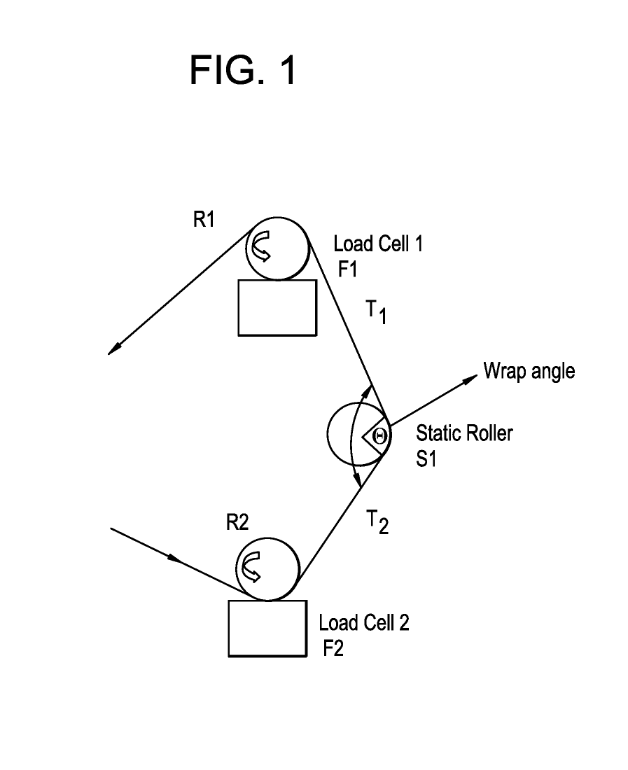

The roller elements of an inventive apparatus are shown in FIG. 1. According to Amonton's Law, the out-going leg tension, T1, to the incoming leg tension, T2, is related directly to the friction coefficient of the two contacting surfaces about a static (non-rotating) roller, S1, as shown in Equation 1:

$$\frac{{T}_{1}}{{T}_{2}} = {e}^{μΘ} . \qquad ( Eqn . 1 )$$

Equation 1 can be used to determine the dynamic coefficient of friction and the static coefficient of friction. Here, μ is the coefficient of friction (static or dynamic) and θ is the wrap angle about the static roller. In one embodiment, the leg tension T1 is measured using the pair of Load Cells 1 (F1) and the leg tension, T2, is measured using the pair of Load Cells 2 (F2). The position of the static roller, S1, can be adjusted so that the wrap angle θ can be adjusted, for example a wrap angle from 0 to 180°, more preferably, from 0 to 90°, and most preferably from 0 to 45°. Additionally, the roller material or coating can be changed to provide for the desired type of material for COF measurements, and/or to provide an appropriate texture. Typical roller surfaces include metals and polymers (for example, rubbers, polyolefins, polyamides and polyesters). The roller surface may be textured. Examples of such materials or coatings can be aluminum, hard anodized aluminum, stainless steel, elastomer or rubber, and other plastics. Roller texture can be characterized by the standard roughness scale such as a “Ra scale.”

The tensions of the two legs from a frictional point/roller (non-rotating) can be measured using tension, compression, or torsional load cells, and the ratio of these tensions is used for determination of the coefficient of friction of the material, such as a polymeric film. Optionally, the static roller can also rotate, and a braking system can be used to stop or reduce the roller speed for a COF measurement. Additionally, the surface temperature of the static roller can be regulated using various types of temperature controlling devices, such as heating cartridges, cooling holes or channels, and the like.

Example of an Inventive At-line COF tester

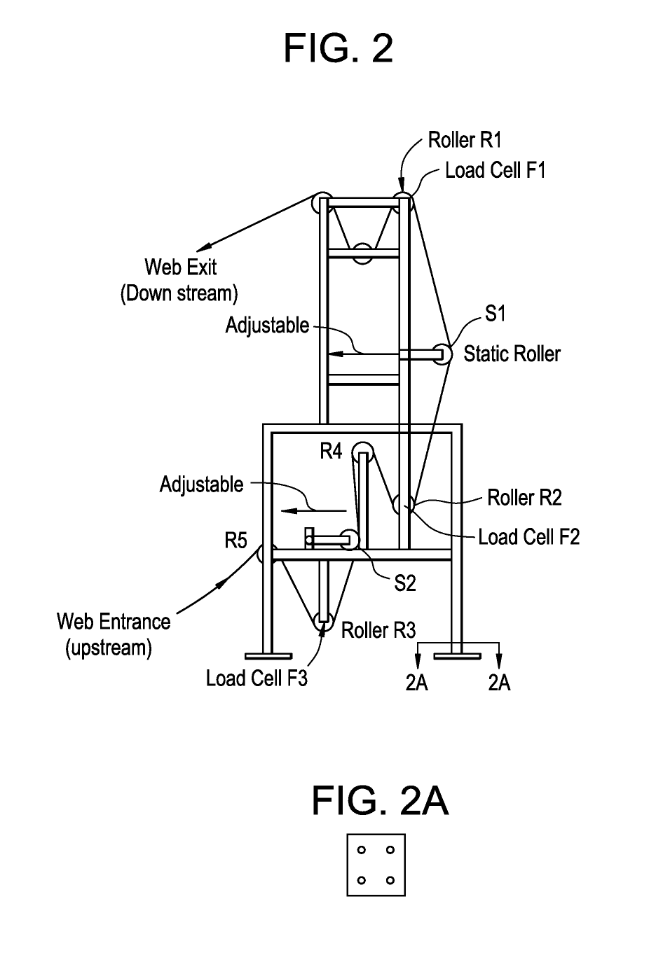

A conceptual example of an inventive “at-line COF apparatus” is shown in FIG. 2. Here, the dynamic friction coefficient (COF) of a film (web) can be determined from the web tension before and after contact with a static roller (S1).

FIG. 2 shows the film web path and key elements associated with this design. The width of the unit can be of any size. The static (S1) in FIG. 2 is the roller that is adjustable in its location, so that the wrap angle can be adjusted.

As discussed above, a braking system can be installed on this roller to stop the roller from rotating when the determination of COF (dynamic and/or static) is desired. At normal condition, the roller is freely rotational, and hence the bearings for the rollers must have a very low resistance to rotate. The roller temperature can be kept isothermally for a period of time, by allowing the frictional roller to fully rotate. Therefore, the lowest resistance bearing must be used to reduce or eliminate friction from this source.

As shown, each rotational roller (R1 and R2) is connected to a pair of load cells, and preferably the rollers, with the load cells attached, should be as close to symmetric as possible, about the static roller (S1). The speed of which the coefficient of friction can be determined with this apparatus can be controlled with external equipment such as a slitter/rewinder.

The rollers R1 and R2 that are attached to the bearing units have a low friction. This bearing assembly (which includes the roller shaft, bearings and bearing housing) are then attached to load detection devices, F1 and F2, respectively. The bearing assembly can be attached to the load detection devices using a variety of methods, depending on the type used. An example would be to attach the bearing assembly on top of the load detection devices, such as in a vertical pillow block. The bearing assembly may also be attached to the load detection device in the horizontal direction, also known as the horizontal pillow block. In another example, the rollers are mounted onto a low friction bearing, which is mounted directly to a radial tension load cell, such as an ABB PRT tension load cell, available from ABB Automation Technologies. These attachments means and others are well known in the art.

In FIG. 2, three sets of load cells (F1, F2 and F3) are shown. One set of load cells (F3) is used to measure the force required to pull the web from the master roll on the slitter/re-winder. This measured force represents the unwinding force of the web roll, and can be used to monitor the blocking force that may occur in the master roll, as it is unwound, and passed through the “at-line COF apparatus.” The second set of load cells (F2) measure the tension, T2, of the web leg prior to the static (non-rotating) roller (S1). The third set of load cells (F1) is located at the top of the frame, and is used to measure the web tension, T1, of the web leg after the static roller. According to Equation 1, the coefficient of friction, μ, can be determined via the ratio of T₁/T₂.

A typical tension applied to polyethylene and polypropylene films is about 0.25 lb/in/mil (lb/width/thickness; a mil is 1/1000 inch). So, for a “4 mil thick” film, the tension would be about “1 lb/in” per film width. For a “36 inch wide” film, which is a typical film width specified for an “at-line” COF apparatus, the typical tension for a film thickness of 4 mils is about 36 lbs. Adding the weight of the roller, the typical load the “at-line COF apparatus” would encounter is from about 38 lbs to 55 lbs. Assuming that the load is evenly distributed across the width of the web, a good resolution load cell would have a capacity up to 50 lbs. Based on this analysis, a 0.2 kN compression/tension load cell is suitable for the system.

As discussed above, the static roller can be designed to be able to roll when it is not needed for measuring the friction of the web in contact with the roller surface. A braking system can be used to stop this roller for measuring COF. The brake can be applied during the COF measurement cycle through application of plant air, or through a mechanical means, to prevent the roller from rotating as the web passes through it.

In one embodiment, the braking system used for the static roller is a MONTALVO C-series Braking System, available from Montalvo Corporation, and designed to be installed at one end of the static roller.

Additionally, due to the alignment of the rollers, a self aligning bearing housing can be used. An “SY ¾ TF” ball bearing unit, available from SKF USA Inc., can be used in an inventive apparatus. For enhanced frictionless properties, the bearing grease can be blown out, and bearing unit can be washed with an alcohol (for example, ethanol) and dried. After it is dried, a low viscosity oil (about one drop), such as a “WD-40” oil, can be introduced into the bearing housing as a lubricant. The frictionless bearing system does not affect, or very minimally affects, the load measurement for COF. Preferably the bearing system is low cost.

### Data Acquisition

For the determination of the “coefficient of friction (dynamic or static)” and the “pull force,” the force signals from the three sets of load cells can be recorded using a stand alone computer. The signal from the load cells (F3), used to detect the load from the release of the film on the master roll on the slitter/rewinder, is sent to a data conditioner/controller, and the other two sets of load cell outputs (F1 and F2) are collected using a data acquisition conditioner/controller. These conditioner/controller devices are used to amplify and convert the signal output from the load cells from analog to digital. The signals from these controllers are then sent to a stand alone computer with data acquisition device and software. The computer software converts the data into COF and/or “pull force” values.

### Definitions

The term “coefficient of friction,” as used herein, refers to the proportional scalar value that relates the frictional force to the normal force on an object, and describes the slip behavior of a surface of the object in contact with another surface. The dynamic friction coefficient (also known as the kinetic coefficient of friction) describes the slip behavior at steady state condition of a surface sliding on another surface. The static coefficient of friction describes the condition upon initiation of the sliding action.

The term “wrap angle,” as used herein, refers to the angle that is formed by the material (for example, a web) surface wetting (contacting) on a roller surface. This angle is illustrated in FIG. 1 as angle θ. The angle θ is the angle formed by the two radii extending from the center point of the roller, each to the respective tangential surface where the web contacts the roller.

The terms “web” or “sample web,” as used herein, refer to a continuous sample (for example, a sheet, film or fiber) that is fed through a series of rotary shafts, such as rollers.

The term “film web,” as used herein, refers to a continuous film that is fed through a series of rotary shafts, such as rollers. An example of a film web is shown in FIG. 2.

The term “slitter,” as used herein, refers to an apparatus or equipment that is used to slit films or sheets.

The term “re-winder,” as used herein, refers an apparatus or equipment that is used to rewind rolls of film or sheet.

The term “slitter/re-winder,” as used herein, refers to an apparatus or equipment that has both the slitting and rewinding functionalities.

The term “pull force,” as used herein, refers to a force or load that is required to release or pull a film or sheet from its roll.

The term “at-line,” as used herein, refers to a portion of a manufacturing line or complete functional line, but which is not an integral portion of the line. A line is an assembly of equipment or apparatus that is combined to produce a function.

The term “on-line,” as used herein, refers to a portion of a manufacturing line or complete functional line, but which is an integral part of the line. As discussed above, a line is an assembly of equipment or apparatus that is combined to produce at least one function.

The term “off-line,” as used herein, refers to a portion of a line which is independent of a manufacturing line or complete functional line.

The term “static roller,” “stationary roller,” and “frictional roller,” as used herein, refer to a roller or shaft (cylinder) that is not rotating (no rotation about its cylinder (length) axis).

The terms “static,” “stationary,” and “frictional,” as used herein, mean non-rotating.

The term, “force detector,” as used herein, refers to an apparatus or unit or equipment that is used to measure the force, load, strain, or torque, on an object.

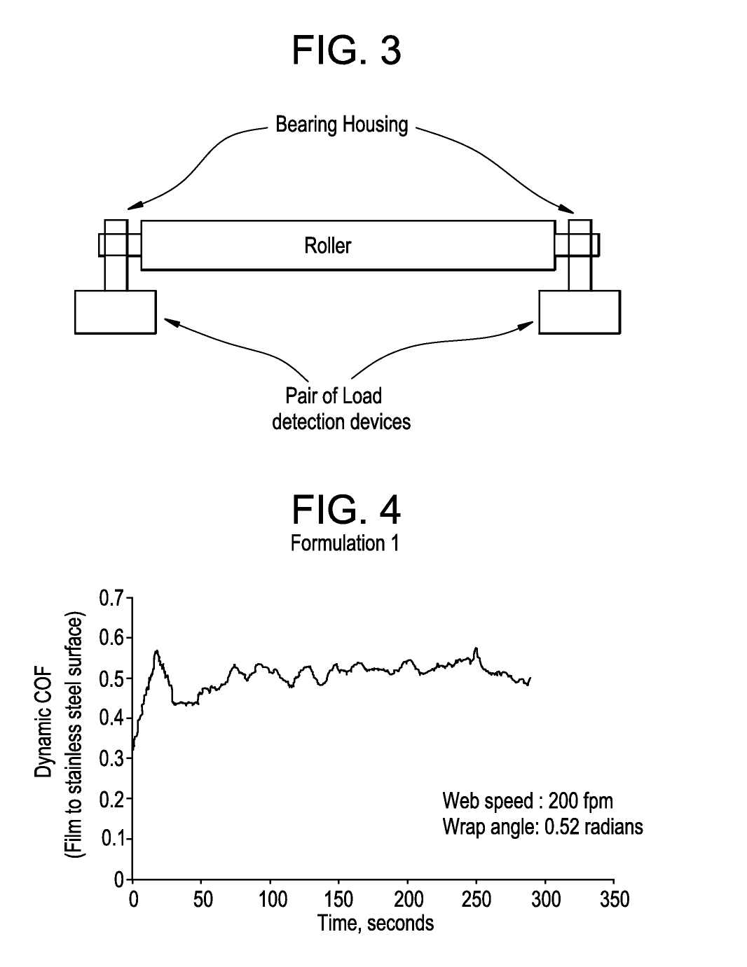

The term “set of force detectors,” as used herein refers to at least two force detectors, or an apparatus containing the same. The force detectors are typically located on opposite ends of a roller. Typically, a roller is set in a bearing housing, which is attached to a force detector located at each end of the roller, as shown in FIG. 3. Two sets of force detectors refer to at least four force detectors. Three sets of force detectors refer to at least six force detectors.

The term “web driver unit,” as used herein, refers to the drive unit (includes the motor, transmission and controller) of a sample web.

The term “freely rotating roller,” as used herein, refers to a roller (rotary shaft) that can rotate about its axis freely, and in which very low frictional forces are exerted by the bearings (or low frictional bearings) at the ends of the roller. The term “low frictional bearings,” as used herein, refers to bearings with negligible frictional loss as determined using the following method. As an example, for an inventive apparatus as shown in FIG. 2, a cable is threaded through all the rollers with the exception of static roller S2. One end of the cable is tied to roller R5, and a known weight is hung at the other end at the web exit. In this measurement, the static roller S1 is set to freely rotate. The measurement is done for at least two known weights, and a linear correlation between the applied load and the measured load can be made for each pair of load cells. The frictional load loss can be characterized using the slope of the linear correlation between the applied load and the measured load for each pair of load cells F1, F2 and F3. For a low frictional bearing, it is preferably that the slope should not deviate more than ±5% from a “slope of one (no loss condition),” more preferably, should not deviate more than ±3%, and most preferably should not deviate more than ±2%. For example, using the apparatus shown in FIG. 2 and the bearing units used as described on page 14, lines 6-13, the following data, as shown in Table 1, was obtained. One skilled in the art can readily alter this test method to fit other apparatus designs.

TABLE 1

| | Applied | F3 | | F1 | | F2 | |
|---|---|---|---|---|---|---|---|
| Load | Load | Average, | STD | Average, | STD | Average, | STD |
| (lb) | (N) | N | Dev | N | Dev | N | Dev |
| 0 | 0 | −0.03 | 0.05 | −0.35 | 0.06 | 0.17 | 0.06 |
| 1 | 4.45 | 4.38 | 0.06 | 4.52 | 0.07 | 4.81 | 0.07 |
| 2 | 8.91 | 8.41 | 0.07 | 8.80 | 0.07 | 9.14 | 0.07 |
| 5 | 22.27 | 22.23 | 0.07 | 22.44 | 0.05 | 22.72 | 0.06 |
| 10 | 44.54 | 45.03 | 0.06 | 45.33 | 0.05 | 45.71 | 0.06 |
| | Slope | 1.0001 | | 1.0185 | | 1.0104 | |

The phrase “continuous measurements of coefficient of friction,” as used herein, refers to the continuous data acquisition(s) of the coefficient of friction, with respect to the length of the sample (for example, a film or sheet), as such is passed through an inventive apparatus. For the continuous measurement of the static coefficient of friction, the sample will move in a “start-stop” manner within the apparatus.

The phrase “continuous measurement of the coefficient of friction and pull force,” as used herein, refers to the continuous data acquisitions of the coefficient of friction and pull force, with respect to the length of the sample (for example, a film or sheet), as such is passed through an inventive apparatus.

The phrase “the coefficient of friction and pull force are simultaneous measured,” as used herein, refers to the measurement, at the same time, of both the coefficient of friction and pull force, each at different locations on a sample (for example, a film web).

### Experimental

### Materials

DOWLEX 2045G—Low density polyethylene (LDPE), density of 0.92 g/cc with a melt index of 1 dg/m, obtained from The Dow Chemical Company.
Anti-block Agent 1 (SiO2 Masterbatch) is a polyethylene masterbatch containing SiO2.
Slip Agent 2 (Erucamide) is a polyethylene masterbatch containing erucamide.

Polymer formulations are shown in Table 2 below.

TABLE 2

| | Formulation | | |
|---|---|---|---|
| | 1 | 2 | 3 |
| DOWLEX 2045G (lbs) | 98.75 | 98.15 | 97.250 |
| Anti-block Agent 1 (lbs) | 1.25 | 1.25 | 1.25 |
| Slip Agent 2 (lbs) | 0 | 0.6 | 1.5 |
| Total (lbs) | 100 | 100 | 100 |

Each formulation was formed into a monolayer, blown film. Each monolayer film (about 2 mils thick) was obtained using a monolayer blown film line, equipped with a two inch, single-screw extruder and a “23.5 inch” layflat die set at “70 mil” die gap. The extruder conditions for extruding the film were as follows:

### Barrel 1 Temperature set (° F.)—375,

### Barrel 2 Temperature set (° F.)—425,

### Barrel 3 Temperature set (° F.)—350,

### Barrel 4 Temperature set (° F.)—350,

### Barrel 5 Temperature set (° F.)—350,

### Screen Changer Temperature (° F.)—450,

### Screw Speed (RPM)—74, and

### Melt Temperature (° F.)—445.

The Die settings were as follows:

### Adaptor Temperature set (° F.)—450,

### Rotator Temperature set (° F.)—450,

### Lower die Temperature set (° F.)—450, and

### Upper die Temperature set (° F.)—450.

### At-Line COF Testing

An “at-line” apparatus was designed and built according to the schematic shown in FIG. 2. The COF testing was done using a stainless steel, static (non-rotating) roller surface. The “at-line” testing was done in conjunction with a slitter/rewinder. The film roll was mounted on the slitter/rewinder, and the web was threaded through the “at-line” COF testing apparatus, and back to the slitter/rewinder drive roller. The film web motion was controlled using the slitter/rewinder control system, located at the web entrance. The wrap angle (θ) was 0.52 radians. Each roller (see FIG. 2), except for roller S2, was made of hard anodized aluminum, and had a “2 ½ inch” diameter. Roller S2 was a stainless steel pipe with a one inch diameter. Also, the static (non-rotating) roller S1 had a stainless steel surface attached to the hard anodized aluminum. The stainless steel surface was a half shaft (from a pipe that was cut along the length of the cylinder) that was attached to static (non rotating) roller using U-bolts at each end of the shaft.

The dynamic coefficient of friction was tested at a web linear speed of 200 feet per minute. The forces registered in the set of load cells F1 and F2 were recorded using an attached computer system, equipped with a National Instrument data acquisition system, which included a data acquisition board, an NI-PCI 6220 M series DAQ and LAB VIEW software. The dynamic COF of the film to the stainless steel surface was then determined using the Amonton's law (see Equation 1) through the measurement of the web tension.

The dynamic COF for the entire roll of film (approximately 1000 feet) was determined. Data points were taken every 0.2 second. The dynamic COF profile of the full roll of film, as measured for Film 1,” is shown in FIG. 4. For this study, an average dynamic COF value was calculated, by taking the average of COF values determined from 10 second to 100 seconds of data acquisition time (a total of 450 data points). This time frame was chosen arbitrarily, and was used to show the consistency of the COF determination. The average COF values are shown below in Table 3.

Also included in Table 3, for comparison, are “off-line, kinetic COF (dynamic)” values, measured for the same films, for a film to metal interface (O/M), and a film to film interface (O/O). Each comparative COF was measured using a standard COF tester available from TMI, in accordance with ASTM-D1894. The listed COF (dynamic) value was the average of five samples. Each sample was a strip of film cut out from different sections of the film roll.

TABLE 3

| | | Off-Line | Off-Line | |
|---|---|---|---|---|
| | | COF* | COF* | At-Line Dynamic COF |
| Film | Formulation | (O/M) | (O/O) | (O/SS) |
| 1 | 1 | 0.38 | 0.57 | 0.52 ± 0.04 (n = 450) |
| 2 | 2 | 0.23 | 0.29 | 0.4 ± 0.11 (n = 450) |
| 3 | 3 | 0.17 | 0.13 | 0.17 ± 0.01 (n = 450) |

*Dynamic COF

As shown in Table 3, the inventive apparatus provided excellent COF results with low standard deviations, and was able to differentiate the slip behavior of each of the films produced. Successful results were obtained using a continuous, “at-line” determination of COF. In addition, the apparatus can be also used to measure “point by point” dynamic COF of the film, as it passes through the apparatus, and can also be used to measure the COF as a function of the speed of the web.

Although the invention has been described in considerable detail in the preceding examples, this detail is for the purpose of illustration, and is not to be construed as a limitation on the invention as described in the following claims.

1. An apparatus for the continuous measurement of the dynamic coefficient of friction and/or static coefficient of friction of a material, which comprises at least the following:
A) two freely rotating rollers, R1 and R2,
B) one roller S1,
C) optionally, one static roller S2,
D) two sets of force detectors, F1 and F2, and
wherein S1 is located between R1 and R2 to form a wrap angle (θ), and wherein the wrap angle (θ) is less than 90°, and
wherein F1 is attached to R1, and F2 is attached to R2.

2. The apparatus of claim 1, wherein the dynamic coefficient of friction is measured.

3. The apparatus of claim 1, wherein the material is a film, sheet or fiber.

4. The apparatus of claim 1, wherein the apparatus is part of a manufacturing line.

5. The apparatus of claim 1, wherein the two rollers R1 and R2 have the same diameter.

6. The apparatus of claim 1, wherein the wrap angle is less than, or equal to, 60°.

7. The apparatus of claim 1, wherein the wrap angle is less than, or equal to, 45°.

8. The apparatus of claim 1, wherein the wrap angle is less, or equal to, than 30°.

9. The apparatus of claim 1, wherein S1 can be rotational or stationary.

10. The apparatus of claim 1, wherein each roller, R1, R2 and S1 has the same diameter.

11. An apparatus for the continuous measurement of the coefficient of friction (dynamic and/or static) and the pull force of a material, which comprises at least the following:
A) two freely rotating rollers, R1 and R2,
B) three rollers, R3, R4 and R5,
C) one roller S1,
D) optionally, one static roller S2,
E) three sets of detectors, F1, F2 and F3, and
wherein S1 is located between R1 and R2 to form a wrap angle (θ), and wherein the wrap angle (θ) between R1 and R2 is less than 90° (1.57 radians), and
wherein R3, R4 and R5, are each located upstream from R2; and
wherein F1 is attached to R1, F2 is attached to R2, and F3 is attached to R3.

12. The apparatus of claim 11, wherein the dynamic coefficient of friction is measured.

13. The apparatus of claim 12, wherein the coefficient of friction and the pull force are simultaneous measured.

14. The apparatus of claim 11, wherein the material is a film, sheet or fiber.

15. The apparatus of claim 11, wherein the apparatus is part of a manufacturing line.
